(19) United States
(12) Patent Application Publication
(10) Pub. No.: US 2006/0103666 A1
(43) Pub. Date: May 18, 2006

(54) Operating apparatus and remote control system

(75) Inventor: Koji Kita, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/183,660

(22) Filed: Jul. 18, 2005

(30) Foreign Application Priority Data
Nov. 15, 2004 (JP) 2004-330450

(51) Int. Cl. G09G 5/00

(52) U.S. Cl. 345/619

(57) ABSTRACT

The operating apparatus having: a display section to display an operation screen showing an item of a function of an equipment; an operating section to accept input of message information for the operation screen displayed on the display section and setting of a display position of the message information on the operation screen; and a controlling section to link the message information and the display position with information of the operation screen at the time when the message information and the display position are set and input.

### BACKGROUND OF THE INVENTION

1. Field of the Invention

The present invention relates to an apparatus to be operated by a user such as a copying machine, a printer, a facsimile, or a complex machine of them. Moreover, the present invention relates to a system for making it possible to remote-control such apparatus through a network.

2. Description of the Related Art

Recently, various types of image forming systems are proposed in each of which an image forming apparatus such as a copying machine for forming an image on a recording medium such as paper and outputting the image is connected with a remote controller such as a PC (Personal Computer) to be remote-controlled through a network and the image forming apparatus is operated by sending an operation instruction from the remote controller or an operation screen of the image forming apparatus is displayed on the operation screen of the remote control system.

For example, JP-Tokukai-2001-306204A discloses an image processor serving as a user-setting common system in which a user-setting common file in which user setting contents are described is read through a storage medium or a network, and the specification of an operation screen displayed on the operation panel is customized by an operation panel controlling section in accordance with the description in the read setting common file.

Moreover, in the case of information processor disclosed in JP-Tokukai-2000-357072A, a host computer, a printer, and a digital copying machine serving as information processors respectively have a function sending or obtaining a device ID for specifying a function of a device together with a network ID assigned to a local area network, converting an operation instruction into a format which can be read by an operating-source equipment and an operating-destination equipment to send or obtain the operation instruction, substituting the operation instruction which is not present in the operating-source equipment exists in operation instructions in the operating-destination equipment, and sending image information.

Furthermore, JP-Tokukai-2002-281195A discloses a remote control system of OA equipment. The remote controller displays an operation screen almost the same as that of a display of OA equipment on the display section of the remote controller by using component data serving as basics for displaying the operation screen according to the set information input from the OA equipment. Then, when the remote controller is operated through an operation screen of the display section, the apparatus sends an operation instruction and an indication change content to the OA equipment. The OA equipment performs an operation in accordance with an operation instruction input from the remote controller to update an indication on the display in real time in accordance with the content change to be displayed.

The information such as auxiliary operation instruction, attention arousal, or memorandum (e.g. “don't leave original after copying!!”, “color sheets are present in tray 3.” and the like.) for various operation screens to be displayed on the display section of an image forming apparatus is frequently attached to a portion near the display section or a side of the apparatus. Therefore, a user must search corresponding information for each operation screen and thus, usability is not good.

Moreover, in the case of a POD (Print On Demand) apparatus using the above system, it is assumed that a remote operator monitors a unit state while referring to various operation screens displayed on the display section of an image forming apparatus. Therefore, it is requested to efficiently operate an apparatus by displaying the information such as auxiliary operation instruction, attention arousal, or memorandum on the operation screen on the display section of the image forming apparatus from a remote control system.

### SUMMARY OF THE INVENTION

The present invention is made in view of the above situation, and its object is to realize an apparatus and a system in which operability is improved by displaying message information for various operation screens on various operation screens.

To solve the above problems, in accordance with the first aspect of the present invention, the operating apparatus comprises:

a display section to display an operation screen showing an item of a function of an equipment;

an operating section to accept an input of message information for the operation screen displayed on the display section and setting of a display position of the message information on the operation screen; and

a controlling section to link the message information and the display position with information of the operation screen, which is displayed at the time when the message information and the display position are accepted.

Preferably, the operating apparatus further comprises a storage to store the message information, the display position and the information of the operation screen which are linked with one another by the controlling section, wherein the controlling section reads the message information corresponding to the operation screen displayed on the display section from the storage, and displays the message information on the operation screen.

Preferably, the storage stores information obtained by linking the operation screen, which is displayed at the time when the message information and the display position are accepted, with the message information and the display position as a label information.

Preferably, the controlling section displays the label information so that a functional item displayed on the operation screen is visible.

Preferably, the operating apparatus is integrally formed with the equipment.

Preferably, the display position is set to a position preset to display only the label image on the operation screen or an arbitrary position on the operation screen.

Preferably, the operating section comprises a selecting section for selecting whether or not to display the label image on the operation screen.

Preferably, the equipment is connected with the operating apparatus through a network, and preferably, the operating apparatus further comprises a transmission section to send the message information, the display position and the information of the operation screen which were linked with one another by the controlling section to the equipment.

Preferably, the equipment is shared by a plurality of users.

Preferably, the equipment includes an image forming apparatus.

In accordance with the second aspect of the present invention, the remote control system in which an equipment and a remote controller are communicably connected through a network, wherein
the remote controller comprising:

a first display section to display an operation screen sent from the equipment;

an operating section to accept input of message information for the operation screen displayed on the first display section and setting of a display position of the message information on the operation screen; and

a first controlling section to display the operation screen on the first display section, and send the message information and the display position to the equipment, and the equipment comprising:

a second display section to display the operation screen showing an item of a function of the equipment;

a storage to store the message information and the display position received from the remote controller; and

a second controlling section to realize a server to send the operation screen to the remote controller which is connected through a network, registering information in which the message information and the display position received from the remote controller are linked with the operation screen information displayed on the first display section at the time when the message information and the display position were set and input in the storage as a label information, reading out the label information corresponding to the operation screen information to be displayed on the second display section from the storage, and displays a label image corresponding to the label information on the operation screen.

Preferably, wherein the first controlling section displays the operation screen by using a web browser, and the second controlling section realizes a web server.

Preferably, in the remote control system, the equipment includes an image forming apparatus.

### DETAILED DESCRIPTION OF THE DRAWINGS

The present invention will become more fully understood from the detailed description given hereinafter and the accompanying drawings, and thus are not intended as a definition of the limits of the present invention, and wherein;

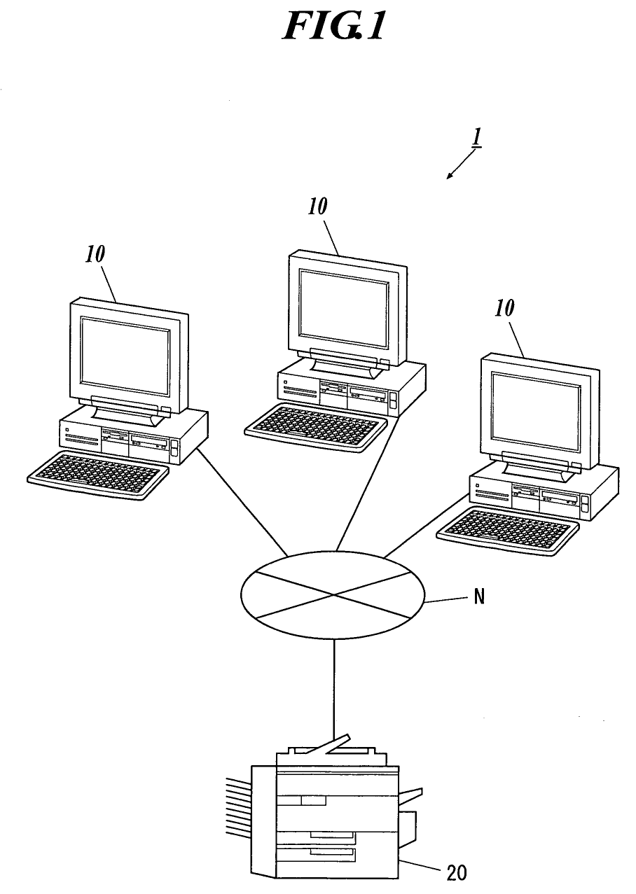

FIG. 1 is a block diagram of an image forming system 1 of this embodiment;

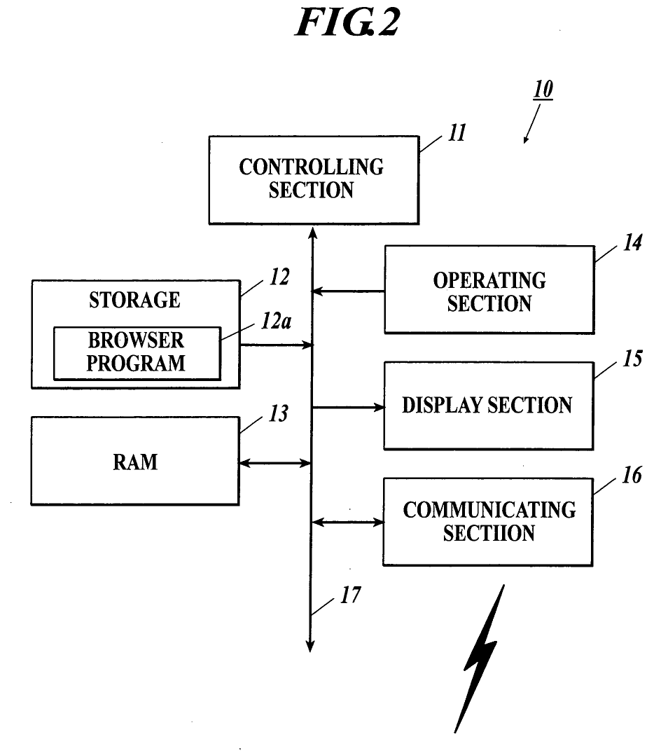

FIG. 2 is an internal block diagram of a remote controller 10;

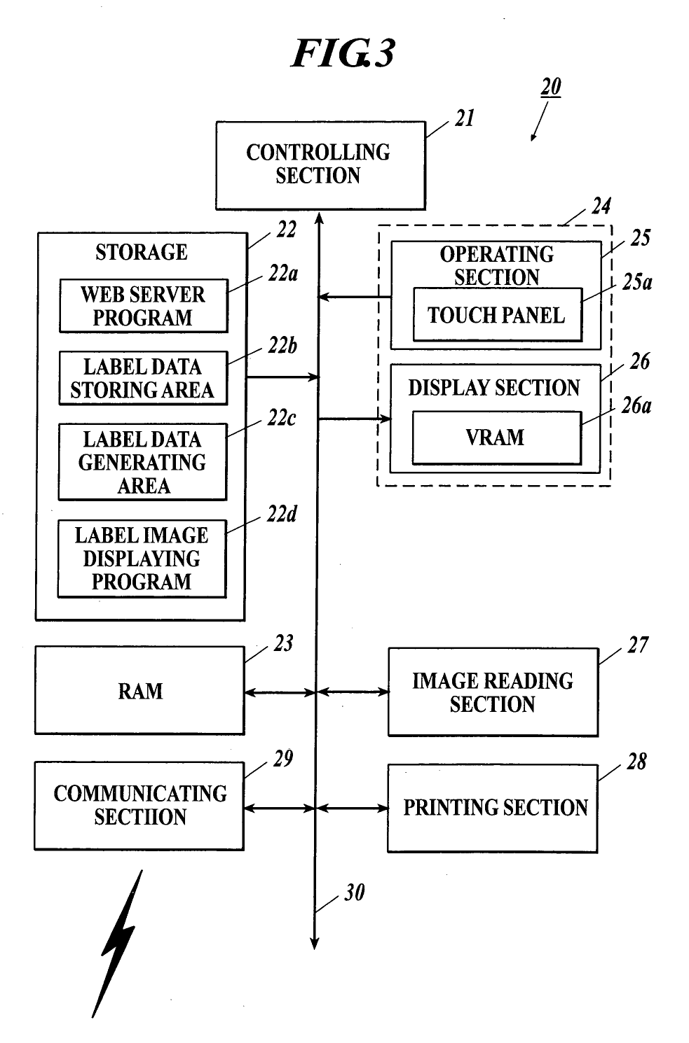

FIG. 3 is an internal block diagram of an image forming apparatus 20;

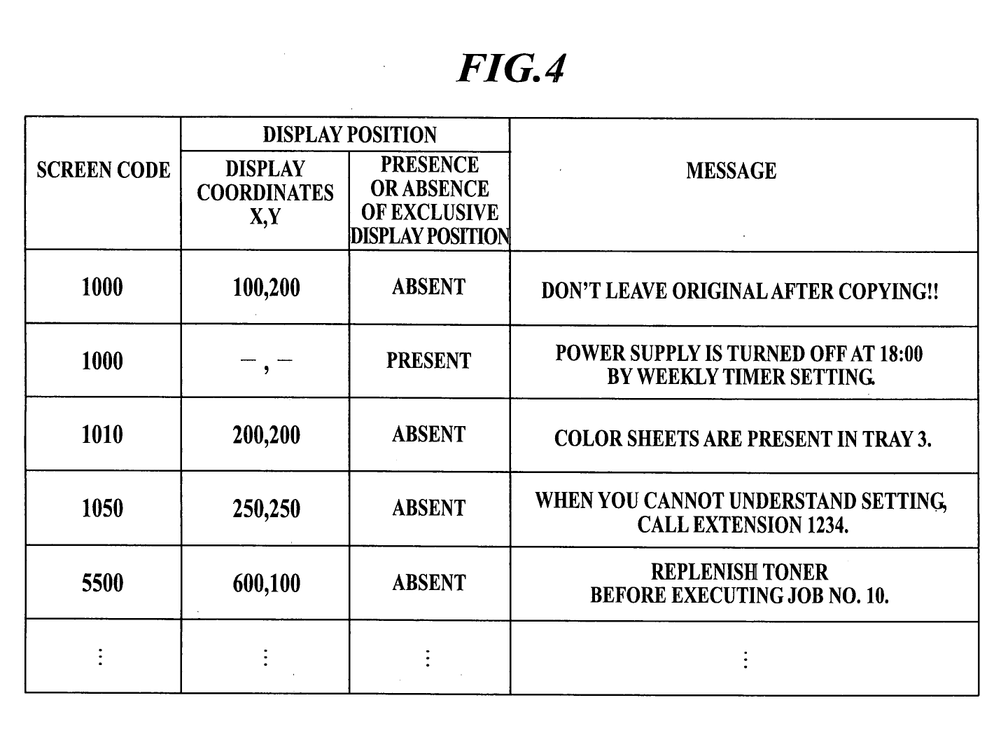

FIG. 4 is an example of label data to be stored in a label data storing area 22b;

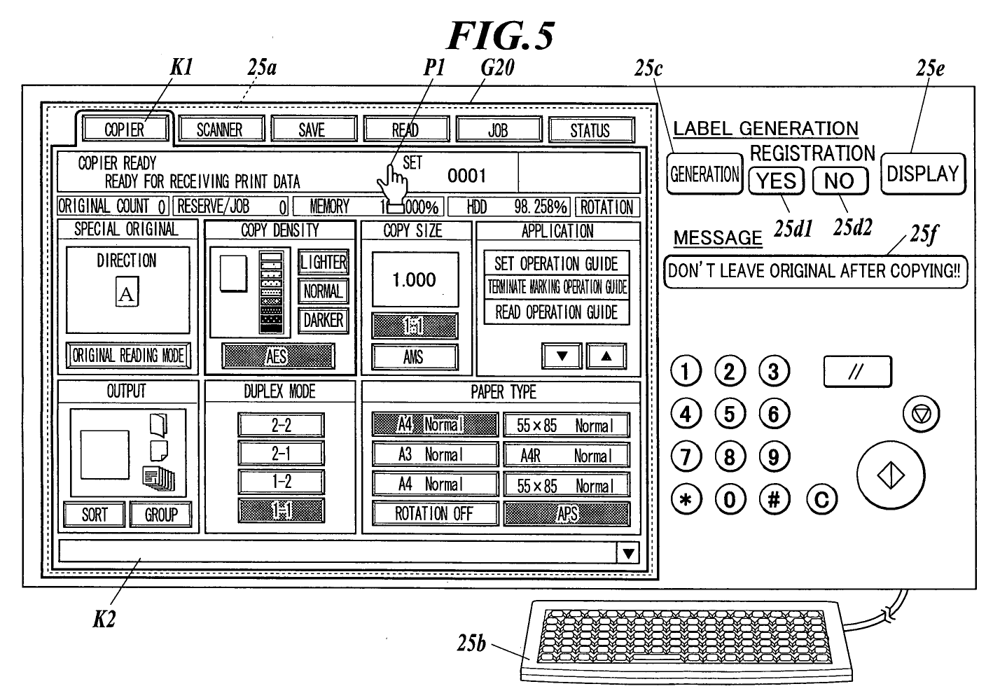

FIG. 5 is an external block diagram of an operation display section 24;

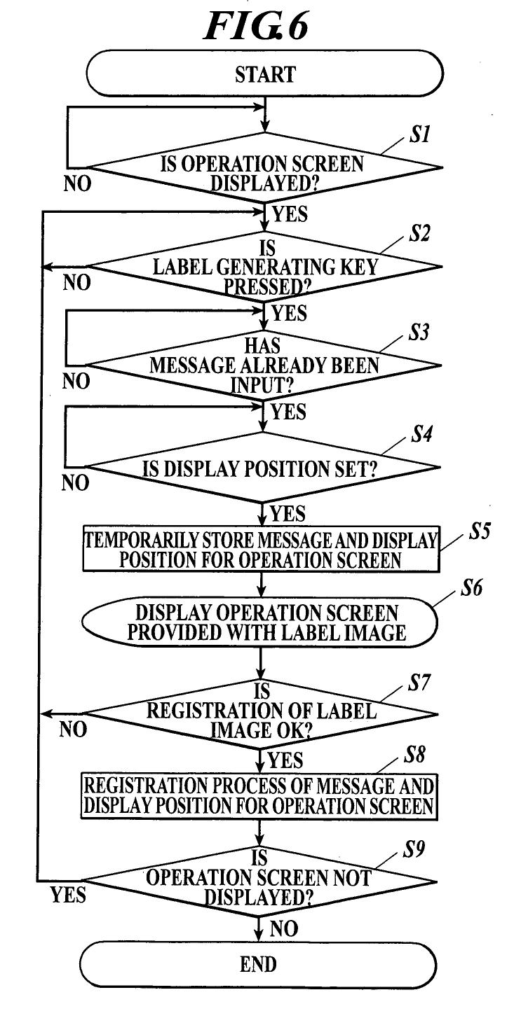

FIG. 6 is a flow chart of a label data generation process in a case where an operator operates an operating section 25 of the image forming apparatus 20 to register a label data;

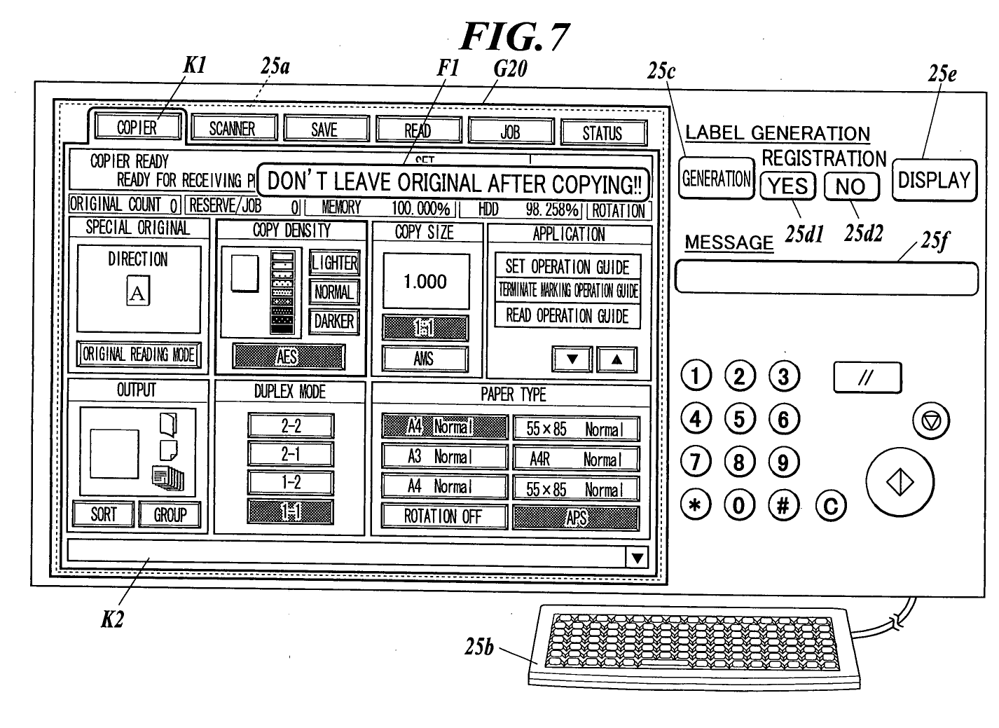

FIG. 7 is an illustration in a case where a label image is displayed an operation screen;

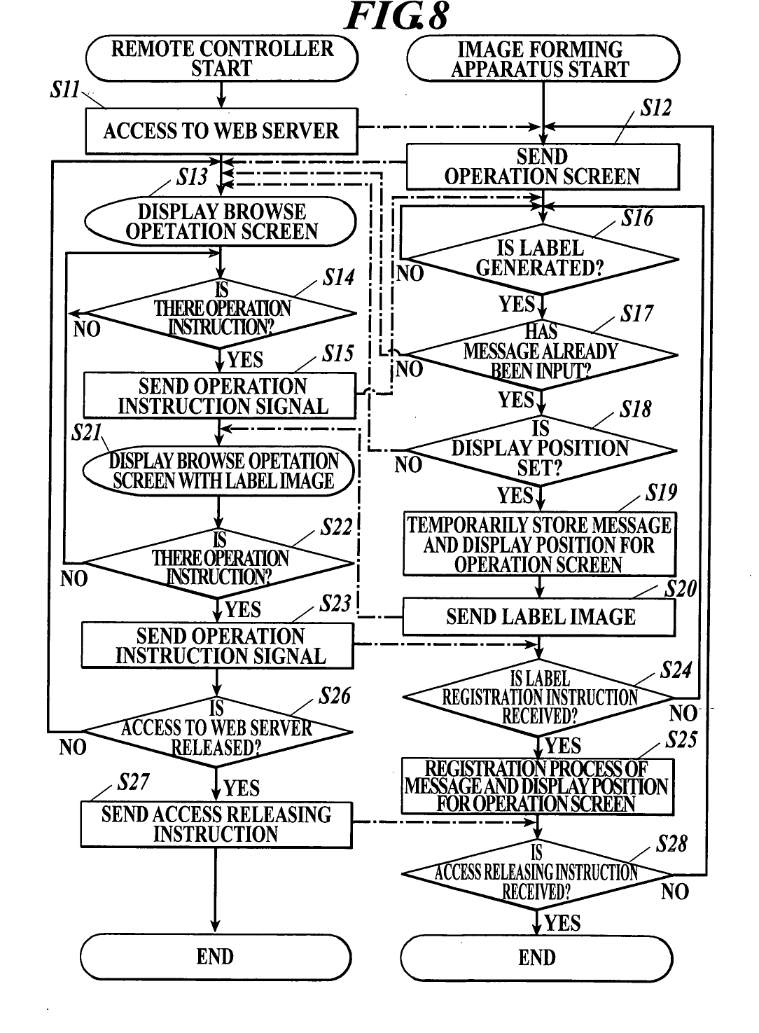

FIG. 8 is a flow chart of a label data generation process in a case where a user operates an operating section 14 of the remote controller 10 to register a label data;

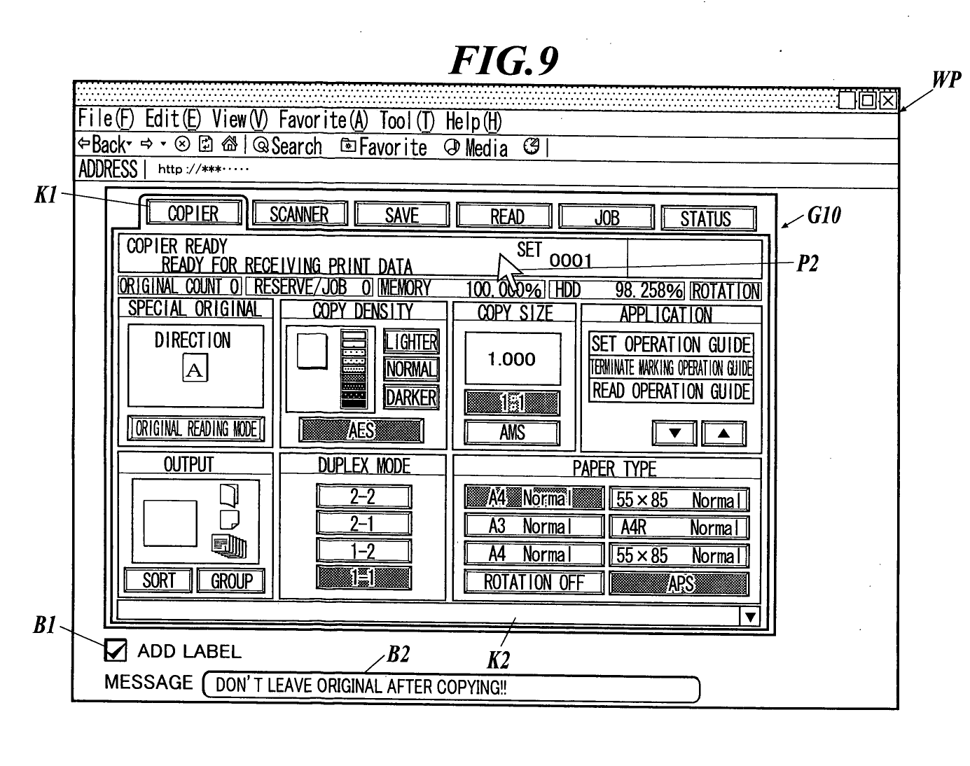

FIG. 9 is an illustration showing one example of a wave page in which a browse operation screen is displayed on a display section 15 of the remote controller 10;

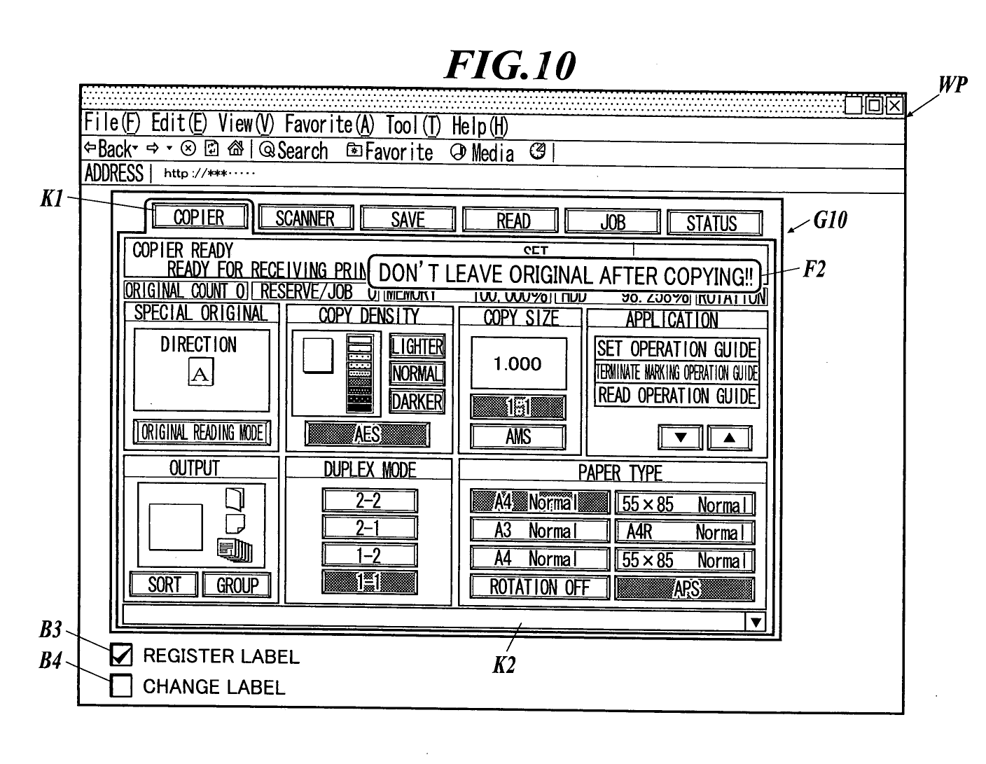

FIG. 10 is an illustration showing one example of a web page in which a label image is displayed on the browse operation screen of the display section 15 of the remote controller 10; and

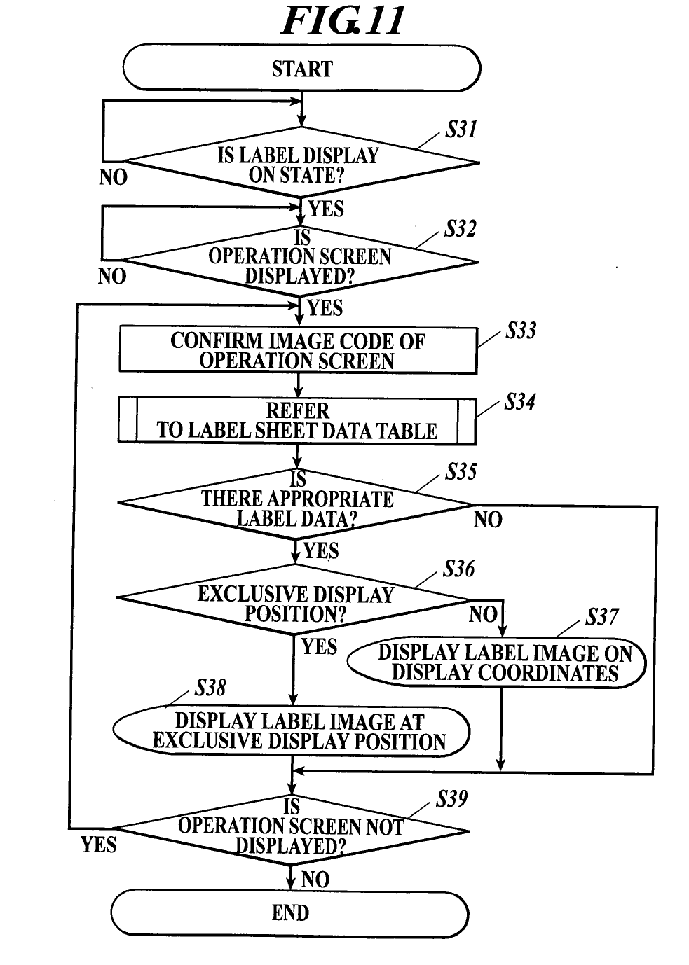

FIG. 11 is a flow chart of a label image display process for displaying a registered label data on an operation screen as a label image.

### DESCRIPTION OF THE PREFERRED EMBODIMENT

In this embodiment, an image forming system is described, in which an image forming apparatus provided with a WWW (World Wide Web) server (hereafter referred to as web server) and a remote controller provided with a platform on which a browsing software such as a WWW (World Wide Web) browser (hereafter referred to as browser) operates are connected each other through a network, and the remote controller can browse and operate a web page for the remote controller which the image forming apparatus provides by the web server by using the browser.

The embodiment of the present invention is described below in detail by referring to the accompanying drawings.

First, a configuration is described.

FIG. 1 shows a configuration of the image forming system 1 of this embodiment.

As shown in FIG. 1, the image forming system 1 comprises the remote controller 10 and an image forming apparatus 20, and each of them is constituted so as to be able to mutually send and receive information through a network N. FIG. 1 shows an example in which three remote controllers 10 and one image forming apparatus are connected. However, the setting number of units is not specifically limited.

The remote controller 10 is for remote-control the image forming apparatus 20, and for example, the remote controller 10 is an apparatus for browsing the operation screen of the image forming apparatus 20 by using a browser and sending an operation instruction performed on the operation screen to the image forming apparatus 20. For example, information processor such as a general-purpose PC can be applied.

Software for providing contents to be browsed by a browser is installed in the image forming apparatus 20. The image forming apparatus 20 is an apparatus having an image forming function and a function as a web server, and performing process in accordance with an operation instruction sent from an operating section set to the apparatus body or an operation instruction sent from the remote controller 10. For example, a copying machine, a printer, a facsimile, and a complex machine of them can be applied.

The network N may be a LAN (Local Area Network) or a WAN (Wide Area Network), or may have a configuration including a telephone network, an ISDN (Integrated Services Digital Network), a broadband communication network, an exclusive line, a mobile communication network, a communications satellite network, a CATV (Community Antenna Television) network, an optical communication network, a radio communication network and an internet service provider for connecting them.

First, the remote controller 10 is described.

FIG. 2 shows an internal configuration of the remote controller 10.

As shown in FIG. 2, the remote controller 10 comprises a controlling section 11, a storage 12, a RAM (Random Access Memory) 13, the operating section 14, the display section 15 and a communicating section 16. These sections are connected through a bus 17 so that they can mutually communicate.

The controlling section 11 comprises a CPU (Central Processing Unit) and the like, develops a system program, various control programs and various data values stored in the storage 12 in the RAM 13 and intensively controls the whole operation of the remote controller 10 in accordance with collaboration with these programs and data.

Moreover, the controlling section 11 performs control so as to display screen data of the operation screen received from the image forming apparatus 20 through the communicating section 16 by using a browser program 12a and various data stored in the storage 12 on the display section 15 as a browse operation screen, and send an operation instruction signal such as a message and a display position of the message as message information which were set and input by the operating section 14 to the image forming apparatus 20.

The storage 12 comprises a nonvolatile storing medium such as a ROM (Read Only Memory) or a HDD (Hard Disk Drive), and stores a system program, various control programs, the browser program 12a for executing a browser and data for these programs in the storing medium.

The RAM 13 forms a work area for temporarily storing various programs to be executed by the controlling section 11 and data for the programs.

The operating section 14 is constituted to comprise pointing devices such as a keyboard composed of numeral keys, character keys, various functional keys and the like for inputting an operation instruction for the image forming apparatus 20 and a mouse, and outputs an operated operation instruction signal to the controlling section 11. Moreover, the keyboard of the operating section 14 is used to input a message as message information constituted of characters, codes, and symbols for a browse operation screen displayed on the display section 15, and the pointing device such as the mouse is used to set a display position of the message on the operation screen.

When the display position of a label image is set by using the operating section 14 of the remote controller 10, the display position is set in accordance with the coordinates clicked according to a mouse pointer on a browse operation screen displayed on a web page. When an exclusive display position displayed on a browse operation screen is clicked, the display position is set as the exclusive display position. When another position is clicked, the clicked position coordinate is set as a display coordinate.

This embodiment shows a case in which a display position is set by using the mouse, however, this embodiment is not limited to the above case. It is also allowed to set a display position by using a graphic tablet or the like.

The display section 15 is constituted by comprising an LCD (Liquid Crystal Display) to display various things in accordance with control signals input from the controlling section 11, and displays input contents of the operating section 14 and screen data as an operation screen sent from the image forming apparatus 20 through the communicating section 16 as a browse operation screen on a web page by using a browser.

The communicating section 16 is constituted by comprising various interfaces such as a network interface card (NIC), a modem (Modulator-Demodulator), and a USB (Universal Serial Bus) to send and receive information to and from an external unit on the network N.

Next, the image forming apparatus 20 is described below.

FIG. 3 shows an internal configuration of the image forming apparatus 20.

As shown in FIG. 3, the image forming apparatus 20 comprises a controlling section 21, a storage 22, a RAM 23, the operation display section 24, an image reading section 27, a printing section 28, and a communicating section 29. These sections are connected through a bus 30 so as to be mutually communicable.

The controlling section 21 has a CPU or the like, develops a system program, various control programs and various data stored in the storage 22 to the RAM 23, and intensively controls each section forming the image forming apparatus 20 in accordance with collaboration with these programs and data.

The controlling section 21 develops a web server program 22a stored in the storage 22 to the RAM 23, executes a web server, and sends a web page on the web server to the remote controller 10 connected with the network N through the communicating section 29.

The web server performs image conversion for converting a operation screen displayed on a display section 26 into, for example, PNG (Portable Network Graphics) type screen data to be a browse operation screen displayed in the browser of the remote controller 10, accumulates the data in the storage 22 by using markup language such as SGML (Standard Generalized Markup Language), HTML (Hyper Text Markup Language), or TEX, and functions to send these screen data through the network N in accordance with a request from the browser of the remote controller 10.

A browse operation screen is an image having a form same as an operation screen displayed on the display section 26. Moreover, an operation screen displayed on the display section 26 is a screen data written in a VRAM (Video Random Access Memory) 26a or a basic image data previously stored in the storage 22.

When the label generating key of the operating section 25 of the image forming apparatus 20 is pressed, the controlling section 21 registers the information, in which a screen code (operation screen information) of an operation screen at the time when a message and a display position of the message are set and input are linked with the message and the display position which were set and input, in the label data storing area 22b of the storage 22 as a label data (label information).

Moreover, the controlling section 21 executes the web server and sends an operation screen displayed on the display section 26 of the image forming apparatus 20 in accordance with a request from the remote controller 10.

When the controlling section 21 receives a signal showing a label generating instruction from the remote controller 10, it registers the information, in which a message and a display position received together with the label generating instruction are linked with a screen code (operation screen information) of an operation screen to a browse operation screen displayed on the display section 15 of the remote controller 10 at the time when the message and the display position of the message received from the remote controller 10 are set and input, in the label data storing area 22b of the storage 22 as the label data (label information).

When there is a label data linked with a screen code of an operation screen among operation screens displayed on the display section 26, the controlling section 21 reads out the label data from the label data storing area 22b and displays a label image corresponding to the read label data on the operation screen. Moreover, the controlling section 21 displays a list of label data registered in the label data storing area 22b on the display section 26.

The storage 22 comprises a nonvolatile storing medium such as a ROM (Read Only Memory) or a HDD (Hard Disk Drive) and stores a system program, various control programs, the web server program 22a for executing a web server, a program requested for image conversion process, the label data storing area 22b, a label data generating program 22c, a label image displaying program 22d, and data for these programs in the storing medium.

FIG. 4 shows an example of a label data stored in the label data storing area 22b.

The label data shown in FIG. 4 is linked with a screen code set for every operation screen for management of operation screens, and set display positions and messages are stored in a data table format. A display position has a display coordinate showing an arbitrary position on the operation screen depending on a user and an exclusive display position previously set to display a label image, and is set so that a message is displayed on either position as a label image.

The RAM 23 forms a work area for temporarily storing various programs to be executed by the controlling section 21 and data for the programs.

The operation display section 24 is provided with the operating section 25 for selecting various functional items and the display section 26 for displaying an operation screen showing owned functional items.

FIG. 5 shows an external block diagram of the operation display section 24. In FIG. 5, “AES”, “AMS” and “APS” stand for Automatic Exposure Selection, Automatic Magnification Selection, and Automatic Paper Selection, respectively.

As shown in FIG. 5, the operating section 25 has various operating hard keys and a touch panel 25a.

Various hard keys are constituted of numeral keys, character keys and various functional keys, and provided with a keyboard 25b for inputting a message serving as message information constituted of characters, symbols and codes for an operation screen, a label generating key 25c provided to instruct label data generation, a registration understanding key 25d1 for registering a label image, a registration changing key 25d2 for changing a label image, a label displaying key 25e for setting whether or not to display a label image, hard keys such as a copy starting key and a ten key, and a message displaying area 25f for displaying a message constituted of characters, symbols and codes input from the keyboard 25b, and operating signals of these hard keys are output to the controlling section 21.

Te touch panel 25a is superimposed on the operation screen G20 displayed on an LCD of the display section 26, and is constituted so as to set a display position of a message on the operation screen G20 by detecting a coordinate which was pressed in accordance with coordinate-reading principle such as an electromagnetic-guidance system, a magnetostriction system, a pressure-sensitive system or the like, and by outputting the detected coordinate to the controlling section 21.

The operation screen G20 shown in FIG. 5 has various operating keys for every operating item area which can be operated when a copy function key K1 is selected and an exclusive display position K2 of a label image. On the operation screen G20 shown in FIG. 5, an operating key of a preset functional item is reversely displayed.

When a display position of a label image is set by using the operating section 25 of the image forming apparatus 20, the display position is set in accordance with the coordinate on the touch panel 25a which was pressed. When the exclusive display position K2 displayed on the operation screen G20 was pressed, the display position is set as the exclusive display position K2. When another position is pressed (for example, when an indicating position P1 shown by the form of a hand shown in FIG. 5 is pressed), the coordinate corresponding to the position which was pressed is set as the display position.

In this embodiment, it is also allowed that the label generating key 25c, the registration confirming keys 25d1 and 25d2, the label displaying key 25e, and the message displaying area 25f are formed on an operation screen. However, when a configuration capable of instructing label data generation and display instruction to the controlling section 21 is used, the configuration is not limited to the above mentioned.

The display section 26 comprises a displaying screen such as an LCD (Liquid Crystal Display) and the VRAM 26a for temporarily storing the data for displaying an operation screen showing functional items present on the displaying screen, and performs necessary display processing in accordance with the data written in the VRAM 26a from the controlling section 21.

The image reading section 27 is constituted by including a light source, a CCD (Charge Coupled Device) image sensor or the like under contact glass. The image reading section 27 optically scans an original mounted on the contact glass, making the reflected light subjected to photoelectric-conversion by the CCD image sensor, and thereafter, performing digital conversion to obtain an original image data. The original image data is stored in the printing section 28 as print data.

The printing section 28 is provided with a sheet feeding section (not illustrated) for feeding various recording media to form an image on a specified recording medium in accordance with print data which is instructed to print by the controlling section 21. The printing system may be any one of an electrophotographic system, an inkjet system and the like.

The communicating section 29 is constituted by including various interfaces such as an NIC, a modem and a USB to send and receive information to and from an external unit on the network N.

Then, operation of this embodiment is described.

FIG. 6 shows a flow chart of a label data generation process in a case where a user operates the operating section 25 of the image forming apparatus 20 to register a label data.

The controlling section 21 of the image forming apparatus 20 determines whether or not an operation screen is displayed on the display section 26 (Step S1). When the controlling section 21 of the image forming apparatus 20 determines that an operation screen is not display on the display section 26 (Step S1; No), the controlling section 21 waits until an operation screen is displayed.

When the controlling section 21 of the image forming apparatus 20 determines that an operation screen is displayed on the display section 26 (Step S1; Yes), the controlling section 21 determines whether or not the label generating key 25c of the operating section 25 is pressed (Step S2).

When the controlling section 21 of the image forming apparatus 20 determined that the label generating key 25c is not pressed (Step S2; No), the controlling section 21 waits until the label generating key 25c is pressed.

When the controlling section 21 of the image forming apparatus 20 determined that the label generating key 25c was pressed (Step S2; Yes), the controlling section 21 determines whether or not a message is input by the keyboard 25b (Step S3).

When the controlling section 21 of the image forming apparatus 20 determines that a message is not input (Step S3; No), the controlling section 21 waits until a message is input.

When the controlling section 21 of the image forming apparatus 20 determined that a message was input by the keyboard 25b (Step S3; Yes), the controlling section 21 determines whether or not a user pressed the touch panel 25a and a coordinate which was pressed was input from the operating section 25 (that is, whether or not a display position is set) (Step S4).

When the controlling section 21 of the image forming apparatus 20 determined that a display position is not set (Step S4; No), the controlling section 21 waits until a display position is set.

When the controlling section 21 of the image forming apparatus 20 determined that a display position was set (Step S4; Yes), a screen code of the operation screen displayed on the display section 26 at the time the label generating key 25c was pressed is linked with the message and the display position, and they are temporarily stored in the RAM 23 (Step S5). Then, the message is displayed at the set display position of the operation screen of the linked screen code on the display section 26 as a label image (Step S6). That is, by displaying the label image on the operation screen, it is possible to urge a user to confirm the label image.

FIG. 7 shows an example when a label image is displayed on the operation screen.

A label image F1 shown in FIG. 7 is a label image formed when a message “Don't leave original after copying” is input to the operation screen G20 shown in FIG. 5 and the display position P1 shown in FIG. 5 is set as a display position.

The controlling section 21 of the image forming apparatus 20 determines whether or not either of the registration understanding key 25d1 or the registration changing key 25d2 for determining whether or not to register the label image was pressed (Step S7).

When the controlling section 21 of the image forming apparatus 20 determined that the registration changing key 25d2 was pressed (Step S7; No), the controlling section 21 erases the data of the message and the display position which are linked with the screen code of the operation screen and are temporarily stored in the RAM 23, displays an operation screen on which a label image is not displayed, and determines whether or not the label generating key 25c was pressed (returns to Step S2).

When the controlling section 21 of the image forming apparatus 20 determined that the registration understanding key 25d1 was pressed (Step S7; Yes), the controlling section 21 registers the screen code of the operation screen and the message and the display position linked with the screen code temporarily stored in the RAM 23 in the label data storing area 22b of the storage 22 as a label data (Step S8).

After registration process of the label data (after Step S8), the controlling section 21 of the image forming apparatus 20 determines whether or not an operation screen is displayed on the display section 26 (Step S9).

When the controlling section 21 of the image forming apparatus 20 determined that an operation screen is displayed on the display section 26 (Step S9; Yes), the controlling section 21 determines whether or not the label generating key 25c was pressed (return to Step S2).

When the controlling section 21 of the image forming apparatus 20 determined that an operation screen is not displayed on the display section 26 (Step S9; No), the controlling section 21 completes the label data generation.

Next, FIG. 8 shows a flow chart of a label data generating process in a case where a user operates the operating section 14 of the remote controller 10 to register the label data.

The controlling section 11 of the remote controller 10 accesses the web server of the image forming apparatus 20 in accordance with an operating signal from the operating section 14 to be operated by a user by using a browser (Step S11).

The web server executed by the controlling section 21 of the image forming apparatus 20 receives an access request from the remote controller 10, reads a basic screen data of an operation screen which is previously stored in the storage 22 and displayed on the display section 26, and sends a screen data as a browse operation screen which was generated by subjecting the read data to image conversion process by the controlling section 21 to the remote controller 10 (Step S12).

The controlling section 11 of the remote controller 10 displays the screen data received by using a browser on the display section 15 as the browse operation screen (Step S13).

FIG. 9 shows a web page in which a browse operation screen is displayed on the display section 15 of the remote controller 10 in Step S13.

A browse operation screen G10 shown in FIG. 9 is displayed on a web page WP displayed by using a browser, in which an operating key is displayed for every operating item area which can be operated when the copy function key K1 is selected. In the case of the browse operation screen G10 shown in FIG. 9, an operating key of a preset functional item is reversely displayed, and the browse operation screen G10 is almost the same as the operation screen G20 displayed on the display section 26 of the image forming apparatus 20 shown in FIG. 5.

Moreover, a label generating check box B1 and a message box B2 are displayed on the web page WP displaying the browse operation screen G10 shown in FIG. 9 for every browse operation screen G10 to be able to select and input instruction.

The label generating check box B1 is a check box set so as to be able to select the label data generation, and the message box B2 is a text box for inputting a message constituted of characters, codes, symbols and the like.

After the browse operation screen G10 was displayed on the display section 15 of the remote controller 10 (after Step S13), the controlling section 11 of the remote controller 10 determines whether or not there is an operation instruction for the browse operation screen G10 displayed on the web page WP (Step S14).

When the controlling section 11 of the remote controller 10 determined that there is no operation instruction for the browse operation screen G10 displayed on the web page WP (Step S14; No), the controlling section 11 waits until an operation instruction is input.

When the controlling section 11 of the remote controller 10 determined that there is an operation instruction for the browse operation screen G10 displayed on the web page WP (Step S14; Yes), the controlling section 11 sends an operation instruction signal to the image forming apparatus 20 (Step S15).

The web server to be executed by the controlling section 21 of the image forming apparatus 20 receives the operation instruction signal from the remote controller 10, and the controlling section 21 determines whether or not there is an instruction for generating a label data in the operation instruction signal received by the web server (for example, the controlling section 21 determines whether or not the check box B1 is selected and a check mark is attached to the check box B1) (Step S16).

When the controlling section 21 of the image forming apparatus 20 determined that there is no label generating instruction (Step S16; No), the controlling section 21 waits until an operation instruction signal including a label generating instruction signal is received.

When the controlling section 21 of the image forming apparatus 20 determined that there is the label generating instruction (Step S16; Yes), the controlling section 21 determines whether or not a message is input (for example, the controlling section 21 determines whether or not characters, codes symbols and the like are input into the message box B2) (Step S17).

When the controlling section 21 of the image forming apparatus 20 determined that a message is not input (Step S17), the controlling section 21 makes the remote controller 10 display a browse operation screen showing that a message is not input.

When the controlling section 21 of the image forming apparatus 20 determined that a message is input (Step S17; Yes), the controlling section 21 determines whether or not a display position is set (Step S18).

When the controlling section 21 of the image forming apparatus 20 determined that a display position is not set (Step S18; No), the controlling section 21 makes the remote controller 10 display a browse operation screen showing that a display position is not set.

When the controlling section 21 of the image forming apparatus 20 determined that a display position is set (Step S18; Yes), the controlling section 21 links the screen code of the operation screen corresponding to the browse operation screen in which the label generating check box is selected with the message and the display position, to temporarily store them in the RAM 23 (Step S19). Then, the data for a label image is sent to the remote controller 10 so that the message is displayed as the label image at the display position on the browse operation screen of the linked screen code (Step S20). That is, by displaying the label image on the browse operation screen, it is possible to urge a user operating the remote controller 10 to confirm the label image.

The controlling section 11 of the remote controller 10 receives the label image data and displays the data on the browse operation screen displayed on the display section 15 (Step S21).

FIG. 10 shows an example of a web page in which a label image is displayed on a browse operation screen on the display section 15 of the remote controller 10.

A label image F2 shown in FIG. 10 is displayed on the browse operation screen G10 shown in FIG. 9, in which a sentence “Don't leave original after copying!!” is input as a message. The label image F2 is a label image formed when the position of a P2 shown in FIG. 9 is set as a display position.

Moreover, either a label registering check box B3 or a label changing check box B4 is selectably displayed on the web page WP in which the label image F2 is displayed on the browse operation screen G10 shown in FIG. 10.

The label registering check box B3 is a check box set to register the label image F2, and the label changing check box B4 is a check box to change the label image F2.

After the label image F2 was displayed on the browse operation screen G10 on the web page WP (after Step S21), the controlling section 11 of the remote controller 10 determines whether or not there is an operation instruction for the web page WP on which the label image F2 is displayed on the browse operation screen G10 (Step S22).

When the controlling section 11 of the remote controller 10 determined that there is no operation instruction for the wed page WP on which the label image F2 is displayed on the browse operation screen G10 (Step S22; No), the controlling section 11 waits until an operation instruction is input.

When the controlling section 11 of the remote controller 10 determined that there is an operation instruction for the web page WP on which the label image F2 is displayed on the browse operation screen G10 (Step S22; Yes), the controlling section 11 sends an operation instruction signal to the image forming apparatus 20 (Step S23).

The web server to be executed by the controlling section 21 of the image forming apparatus 20 receives an operation instruction signal from the remote controller 10, and the controlling section 21 determines whether or not there is a label generating instruction in the operation instruction signal received by the web server (for example, determines whether or not the registering check box B3 is selected and a check mark is attached to the check box B3) (Step S24).

When the controlling section 21 of the image forming apparatus 20 determined that there is no label registering instruction (Step S24; No), the controlling section 21 regards the operation instruction signal as a label changing instruction, erases the message and the display position data which are linked with the screen code of the browse operation screen in which the label generating check box is selected and which are temporarily stored in the RAM 23, performs control so as to make the remote controller 10 display a browse operation screen on which a label image is not displayed, and waits until an operation instruction signal including a label generating instruction signal is received (return to Step S16).

When the controlling section 21 of the image forming apparatus 20 determined that there is a label registering instruction (Step S24; Yes), the controlling section 21 registers the screen code of the browse operation screen, and the message and the display position linked with the screen code which are temporarily stored in the RAM 23 in the label data storing area 22b of the storage 22 as a label data (Step S25).

After the controlling section 11 of the remote controller 10 sent the operation instruction signal to the image forming apparatus 20 (after Step S23), the controlling section 11 determines whether or not an instruction for releasing the access to the web server of the image forming apparatus 20 is input in accordance with an operating signal from the operating section 14 operated by a user (Step S26).

When the controlling section 11 of the remote controller 10 determined that the instruction for releasing the access to the web server was not input (Step S26; No), the process returns to Step S13.

When the controlling section 11 of the remote controller 10 determined that the designation for releasing the access to the web server was input (Step S26; Yes), the controlling section 11 sends the instruction for releasing the access to the web server to the image forming apparatus 20 (Step S27).

The web server to be executed by the controlling section 21 of the image forming apparatus 20 determines whether or not the access releasing instruction was received from the remote controller 10 (Step S26).

When the controlling section 21 of the image forming apparatus 20 determined that the access releasing instruction from the remote controller 10 was not received (Step S26; No), the process returns to Step S12.

When the controlling section 21 of the image forming apparatus 20 determined that the access releasing instruction from the remote controller 10 was received (Step S26; Yes), the controlling section 21 completes the label data generation.

FIG. 11 shows a flow chart of a label image displaying process for displaying a registered label data on an operation screen as a label image.

The controlling section 21 of the image forming apparatus 20 determines whether or not the label displaying key 25e is ON state (Step S31).

When the controlling section 21 of the image forming apparatus 20 determined that the label displaying key 25e is not ON state (Step S31; No), the controlling section 21 determines that displaying a label image is not permitted and waits until the label displaying key 25e becomes ON state.

When the controlling section 21 of the image forming apparatus 20 determined that the label displaying key 25e is ON state (Step S31; Yes), the controlling section 21 determines that display of a label image is permitted and determines whether or not an operation screen is displayed on the display section 26 (Step S32).

When the controlling section 21 of the image forming apparatus 20 determined that an operation screen was not displayed on the display section 26 (Step S32; No), the controlling section 21 waits until an operation screen is displayed.

When the controlling section 21 of the image forming apparatus 20 determined that an operation screen is displayed on the display section 26 (Step S32; Yes), the controlling section 21 confirms a screen code of the operation screen to be displayed (Step S33).

The controlling section 21 of the image forming apparatus 20 refers to the label data table registered in the label data storing area 22b (Step S34), and determines whether or not there is a label data corresponding to the confirmed screen code (Step S35).

When the controlling section 21 of the image forming apparatus 20 determined that there is a label data corresponding to the screen code (Step S35; Yes), the controlling section 21 determines whether or not the display position set to the corresponding label data is the exclusive display position (Step S36).

When the controlling section 21 of the image forming apparatus 20 determined that the display position is not the exclusive display position (Step S36; No), the controlling section 21 displays the label image on a position on the operation screen shown by display coordinate (Step S37).

When the controlling section 21 of the image forming apparatus 20 determined that the display position is the exclusive display position (Step S35; Yes), the controlling section 21 displays the label image on the exclusive display position on the operation screen (Step S38).

When there is no corresponding label data (Step S35; No), or after displaying the label image on the operation screen (after Steps S37 and S38), the controlling section 21 of the image forming apparatus 20 determines whether or not an operation screen is not displayed on the display section 26 (Step S39).

When the controlling section 21 of the image forming apparatus 20 determined that an operation screen is displayed on the display section 26 (Step S39; Yes), the process returns to Step S33.

When the controlling section 21 of the image forming apparatus 20 determined that an operation screen is not displayed on the display section 26 (Step S39; No), the controlling section 21 completes the label image displaying process.

As above, the image forming apparatus 20 can display a message constituted of characters, codes, symbols and the like input by the operating section 25 at the set position on the operation screen displayed on the display section 26 as a label image, so that the information such as auxiliary operation instruction, attention arousal, and memorandum can be displayed for each operation screen. Therefore, it is possible to realize the image forming apparatus 20 with improved operability. Moreover, a label image can be easily displayed on the display section 26 of the image forming apparatus 20 from the remote controller 10 without preparing a specific process program for the remote controller 10, so that it is possible to realize an image forming apparatus and a remote control system which are provided with an operating apparatus with improved operability.

Moreover, it is possible to set a display position of an attached image to various operation screens to an exclusive display position or a position based on a display coordinate. Therefore, it is possible to set the display position to a position which can be easily recognized by a user. Thus, it is possible to realize an image forming apparatus and a remote control system provided with an operating apparatus with improved efficiency, in which the time for searching the information for each operation screen can be omitted and an erroneous operation can be prevented.

Moreover, because the label displaying key 25e for setting whether or not to display a label image to the image forming apparatus 20 is provided for the image forming apparatus 20, it is possible to easily display a label image to be displayed on an operation screen. Thus, an image forming apparatus provided with an operating apparatus whose usability is improved for users can be realized.

The above embodiments are configured to set whether or not to display a label image, however, it is allowed to use another form. For example, to display a label image by putting it on an operation screen, it is also allowed to switch between a form to display a label image by simply putting it on an operation screen and a form to display a label image by making it translucent. In the case of the former display form, a user can easily view a label image. However, depending on the display position of a label image, the original display content of an operation screen is hidden and it is impossible to recognize this. However, in the case of the latter display form, a user can view a label image and recognize the original display content of an operation screen.

Moreover, it is allowed to use only the latter display form instead of switching between the former display form and the latter display form. Furthermore, it is allowed to set whether or not to display a label image with the latter display form.

Furthermore, the present invention is not limited to the content of the above embodiment. Various changes may be properly made without departing from the spirit and the scope of the present invention.

What is claimed is:

1. An operating apparatus comprising:
a display section to display an operation screen showing an item of a function of an equipment;
an operating section to accept an input of message information for the operation screen displayed on the display section and setting of a display position of the message information on the operation screen; and
a controlling section to link the message information and the display position with information of the operation screen, which is displayed at the time when the message information and the display position are accepted.

2. The operating apparatus of claim 1, further comprising a storage to store the message information, the display position and the information of the operation screen which are linked with one another by the controlling section, wherein the controlling section reads the message information corresponding to the operation screen displayed on the display section from the storage, and displays the message information on the operation screen.

3. The operating apparatus of claim 2, wherein the storage stores information obtained by linking the operation screen, which is displayed at the time when the message information and the display position are accepted, with the message information and the display position as a label information.

4. The operating apparatus of claim 3, wherein the controlling section displays the label information so that a functional item displayed on the operation screen is visible.

5. The operating apparatus of claim 2, wherein the operating apparatus is integrally formed with the equipment.

6. The operating apparatus of claim 3, wherein the display position is set to a position preset to display only the label image on the operation screen or an arbitrary position on the operation screen.

7. The operating apparatus of claim 3, wherein the operating section comprises a selecting section for selecting whether or not to display the label image on the operation screen.

8. The operating apparatus of claim 1, wherein the equipment is connected with the operating apparatus through a network.

9. The operating apparatus of claim 8, further comprising a transmission section to send the message information, the display position and the information of the operation screen which were linked with one another by the controlling section to the equipment.

10. The operating apparatus of claim 1, wherein the equipment is shared by a plurality of users.

11. The operating apparatus of claim 10, wherein the equipment includes an image forming apparatus.

12. A remote control system in which an equipment and a remote controller are communicably connected through a network, wherein
the remote controller comprising:
a first display section to display an operation screen sent from the equipment;
an operating section to accept input of message information for the operation screen displayed on the first display section and setting of a display position of the message information on the operation screen; and
a first controlling section to display the operation screen on the first display section, and send the message information and the display position to the equipment, and
the equipment comprising:
a second display section to display the operation screen showing an item of a function of the equipment;
a storage to store the message information and the display position received from the remote controller; and
a second controlling section to realize a server to send the operation screen to the remote controller which is connected through a network, registering information in which the message information and the display position received from the remote controller are linked with the operation screen information displayed on the first display section at the time when the message information and the display position were set and input in the storage as a label information, reading out the label information corresponding to the operation screen information to be displayed on the second display section from the storage, and displays a label image corresponding to the label information on the operation screen.

13. The remote control system of claim 12, wherein the first controlling section displays the operation screen by using a web browser, and the second controlling section realizes a web server.

14. The remote control system of claim 12, wherein the equipment includes an image forming apparatus.
